(19) United States
(12) Patent Application Publication
(10) Pub. No.: US 2017/0319423 A1
(43) Pub. Date: Nov. 9, 2017

(54) Crutches and Sitting Device

(71) Applicant: Nami Khademhosseini, Falls Church, VA (US)

(72) Inventor: Nami Khademhosseini, Falls Church, VA (US)

(21) Appl. No.: 14/641,313

(22) Filed: Mar. 7, 2015

(51) Int. Cl. A61H 3/02; A45B 5/00

(52) U.S. Cl. CPC A61H 3/0244; A61H 3/0277; A45B 5/00; A61H 2201/1635

(57) ABSTRACT

The New Design for Crutches and Sitting Device is an improvement of the basic crutch to provide needed support to ameliorate potential injuries and improve ambulation for persons suffering from injured lower limbs, lumbar region or other injuries and who frequently required using crutches for mobility. However, crutches require more energy from the user than merely walking, and frequently, a crutch user may require rest. Prior crutch systems have not provided a convenient way to provide the user with such rest. The current invention fulfills two functions: (i) providing improved walking aid for those recovering from orthopedic surgery of the spine and lower extremities—as well as those who suffer from permanent disability from the spine and lower limbs; and (ii) improved sitting aid for those recovering from orthopedic surgery of the spine and lower extremities—as well as those who suffer from permanent disability of the spine and lower limbs.

### (B) CROSS REFERENCE TO RELATED APPLICATIONS

This application claims the benefit of a U.S. Provisional Patent Application, No. 61/950,002, filing date, Mar. 7, 2014 entitled Back Saver Crutch.

### (C) STATEMENT OF FEDERALLY SPONSORED RESEARCH/DEVELOPMENT

The Design for Crutches and Sitting Device invention was developed without the aid of Federally Sponsored Research and Development Funding.

### (D) THE NAMES OF THE PARTIES TO A JOINT RESEARCH AGREEMENT

Non Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Non Applicable

### (F) STATEMENT REGARDING PRIOR DISCLOSURES BY THE INVENTOR OR A JOINT INVENTOR

Non Applicable

### BACKGROUND OF THE INVENTION

Reduced or inhibited mobility presents a significant problem for many people. Whether it is an injury to the leg, hip, or the result of increased age, mechanical devices are often used for assisting the user to enhance their mobility. Canes, crutches, walking sticks and various other devices have been in use for a considerable time. However, the functional design of these devices has remained substantially the same. Unfortunately for the user, these devices are often cumbersome, uncomfortable, and difficult to use in slippery surface situations and don't support the user's back adequately in the standing or seated position.

Persons suffering from injured lower limbs are frequently required to use crutches for mobility. However, crutches require more energy from the user than merely walking, and frequently, a crutch user may require rest. Prior crutch systems have not provided a convenient way to provide the user with such rest, which necessitate support to the back and lower lumbar region. This support is important to the crutch user in both the standing and seated position.

It would also be advantageous for a crutch, or similarly constructed walking aid, to provide greater comfort for the user. It would be further advantageous for the walking aid to utilize the user's energy in mechanically assisting the user while walking. Furthermore, it would be advantageous for a walking aid to provide enhanced grip on slippery and/or uneven surfaces.

While various modifications have been attempted, there is presently no crutch that incorporates the appropriate ergonomic structure in a light-weight, sure gripping, user friendly, shock absorbing, and collapsible format. The current invention, New Design for Crutches and Sitting Devices, (hereafter may be referred to in this patent as the current or present invention) is designed to ameliorate many health problems caused and exacerbated by the classic crutch design and provide the light-weight, sure gripping, user friendly, shock absorbing, and collapsible format users need. This current invention is also design to provide the support to the back a crutch user requires in both the standing and seated position.

The injuries resulting from the traditional crutch use are in part due to the fact that patients overly rely upon the underarm portion to support the body weight. The New Design for Crutches and Sitting Devices is designed to take considerable pressure from the underarm portion and support the body weight of the user ergonomically. This crutch is design to contour to shape of the axilla. This minimizes potential underarm nerve injuries like neuropraxia and even complete paralysis of the arm. The design also ensures that the pressing weight of the body is not solely directly on the axilla, thus minimizing the occurrence of muscle strain of the arms and shoulders, as well as joint pain to the shoulders.

Additional this improved crutch design will minimize and reduce injuries to the hand and wrist. The hand grip is contoured to fit a patient's palm, designed to maintain the hand and wrist in a neutral position when the crutches are in use or at a 25° angle during ambulation. The general construction and design of existing crutch hand grips does not provide the correct ergonomic orientation between the wrist and forearm even though padding may be present. Failure to achieve correct alignment and padding in the palmar area can result in disorders of wear and tear, including overuse syndromes, repetitive strain injuries, musculoskeletal injuries, and compressive neuropathies. Common injuries resulting in such usage include: carpal tunnel syndrome, wrist tendonitis, medial or lateral elbow epicondylitis, and rotator cuff muscle strains and tears. These disorders appear to be more common in the chronic crutch user, and are the result of repeated stresses on a particular musculoskeletal area. Thus, none of the traditional crutch constructions effectively support the users' body weight or torso in a comfortable manner so that they are able to walk using minimal energy with maximal comfort.

The following prior art references describe adjustable crutches, ergonomic cushions and had grips and curved crutch tips. These prior art, attempt to, but do not comprehensively solve the issues described above and nor do these crutches provide ergonomic back support to a user who is seated. Further, these the adjustable feature of the prior art is generally to support storage the crutch after use. The adjustability of the New Design for Crutches and Sitting Device facilitates a shorter support embodiment to support the user while seated.

### FIELD OF THE INVENTION

Embodiments of the present invention generally relate to an orthopedic device to improve mobility and orthopedic support while seated. More specifically, various embodiments of the present invention relate to multi-stage collapsible crutches that supports while both standing and seated. The applicable U.S. patent classifications are:

135/65, 135/68 135/67 135/71 135/72 135/69. Class 135 comprises portable coverings, formed of flexible material, for protection from mosquitoes, flies, and other insects, and from the weather, frames and supports for the same, and canes and other sticks or staffs used as aids to locomotion.

16/430; 16/422; 16/431; 16/436. Class 16 comprises Handles, Handgrips, Handle Components, and Attachable or Adjunct Handles

521/139; 521/140. Class 521, comprises, Gel, Foams, Synthetic resins or natural rubbers.

### DESCRIPTION OF RELATED ART

### Prior Art: Adjustable Crutches

U.S. Pat. No. 8,844,548 teaches a walking aid support which includes an embodiment that comprises an oval shaped bottom and a downwardly angled slit. This support is configured facilitating walking and providing support in rough terrain.

U.S. Pat. No. 8,800,579 teaches an adjustable crutch designed to address three documented hazards or situations that may cause the crutch user to fall and injure themselves, however, it does not teach the support and amelioration of injuries to the underarm and hand, nor does it support the seated user.

U.S. Pat. No. 8,474,470 teaches an adjustable crutch designed to support an infirmed person's weight while standing but does not support the person's weight while seated.

U.S. Pat. No. 8,418,704 teaches a power adjustable crutch assembly that assisting a user in transitioning between a seated position and a standing position. The assembly includes a support configured for positioning under an arm of a user. An upper frame is coupled to and extends downwardly from the support. A lower frame is slidably coupled to the upper frame. An adjustment assembly is operationally coupled to the lower frame and the upper frame. It does not claim support for the user while seated and as with most adjustable crutches, the adjustable characteristic is for ease of storage and or usage in the standing position, not to support while seated.

U.S. Pat. No. 5,465,745, an adjustable crutch includes upper and lower assemblies which are slidably interconnected with one another and constructed of hollow aluminum pipes; or tubing, interconnected by glass or fiber-reinforced nylon members. The present invention has significantly more features to ensure the safety of the user and the three sliding members per staff allows the crutch to support the user in the seated positon.

U.S. Pat. No. 7,360,547 is for a walking assist device includes an elongate shaft having an adjustable length; a handle detachably connected to a proximal end of the elongate shaft, and a curved elongate base that mate to and engages a distal end of the elongate shaft.

U.S. Pat. No. 7,537,017 teaches a shoulder support assembly for an adjustable crutch. The shoulder support assembly is goaled to solve many of the health issues connected to the usage of the standard crutch, but does provide adequate support and it lacks the obvious advantages of a standard adjustable crutch.

Deficiencies of the embodiments in these prior art references documented above are their lack of ability to balance mobility, walking steadiness, support the back while seated and prevent tripping.

US Patent Application 2013/0263901 teaches a handgrip for a crutch that unlike the claimed Crutch design is offset from the plane of the crutch in both forward and rear end of the grip.

U.S. Pat. No. 8,776,321 teaches an ergonomic hand grip that provides shock absorption and reduces fatigue. More specifically, the present technology is a hand grip of varying thickness to permit support while also absorbing shock and vibration

U.S. Pat. No. 8,950,415 teaches a crutch system with claims pertaining to assembly and disassembly purposes, the assembly and the disassembly of the crutch system adapted to be done in a simple, safe, rapid and economical manner. As with crutches analysis, the detachable claim is related to ease of assembly and not support the crutch user while seated.

### BRIEF SUMMARY OF THE INVENTION

As an Improvement for the Traditional Crutch the current invention may appear to be a form of a traditional crutch. However, the design and function of this device far exceeds those of a traditional crutch/walking/sitting aid. It deals particularly with a more comfortable construction in crutch design. This invention is designed to provide help and relief for more effective ambulation and improved posture, for disabled as well as pre- and post-operative population.

The present invention provides for a crutch base that addresses three hazards of the typical crutch.

1) losing balance on a slippery surface caused by the tip sliding out from underneath the person;

2) hitting an object or an obstacle on the ground with the walker causing the person to continue in motion through inertia, while the walker is stopped by the obstacle; and

3) being restricted by the walker as the person moves forward or slips backward as he/she grabs onto the walker for support, but the walker is insufficiently flexible to move with the person.

A first embodiment of the present invention is configured for persons with a relatively severe handicap and limited moving dexterity generally unable to walk without a walking aid. This embodiment is configured for providing stability in bumpy or slippery walking terrains under a number of adverse situations that may occur. A second embodiment of the present invention is configured for use by persons who are not severely handicapped and use a walking aid, possibly for optional support if, for example, one leg is sore or injured. Such a person would desire flexibility and only minimum movement restriction from the use of the walking aid.

The invention is also adjustable and allows the user to support his/her body weight in the seated position. This allows for more effective rest and reduces stress on the lumbar region. This is important and distinguishes this invention from the prior art. Using this design in the seated position elevates the upper body such that the user's upper body weight does add significant pressures to the lower back and spine. Thus elevating and elongating the upper body reduces the pressure and stress to the lower body ameliorating the possibility of injury. The lower back is vulnerable to body weight pressures while standing and seated and this design minimizes those harmful pressures. This design also effectively supports the user's body weight/torso in a comfortable standing position so that the user is able to walk using minimal energy with maximal comfort.

In addition to supporting the user in ambulation and in the seated position, the design of the underarm cushion reduces stress and injury. This crutch cushion is design to contour to shape of the axilla. This minimizes potential underarm nerve injuries like neuropraxia and even complete paralysis of the arm. The design also ensures that the pressing weight of the body is not directly on the axilla, thus minimizing the occurrence of muscle strain of the arms and shoulders, as well as joint pain to the shoulders. Furthermore, the hand grip is contoured to fit a patient's palm and designed to maintain the hand and wrist in a neutral position when the crutches are in use or at a 25° angle during ambulation. The general construction and design of existing crutch hand grips does not provide the correct ergonomic orientation between the wrist and forearm even though padding may be present. Failure to achieve correct alignment and padding in the palmar area can result in disorders of wear and tear, including overuse syndromes, repetitive strain injuries, musculoskeletal injuries, and compressive neuropathies.

Common injuries resulting from such usage include: carpal tunnel syndrome, wrist tendonitis, medial or lateral elbow epicondylitis, and rotator cuff muscle strains and tears. These disorders appear to be more common in the chronic crutch user, and are the result of repeated stresses on a particular musculoskeletal area.

Thus this improved crutch design reduced injuries in ambulation, injuries to the hand through improved handgrips, injures the axilla due to breathable gel and foam cushioning, and provides the user support and rest while using the crutch while seated.

### BRIEF DESCRIPTION OF THE SEVERAL VIEWS OF THE DRAWING(S)

FIG. 1: Shows a side view of the adjustable current invention, crutch, constructed in accordance with the preferred embodiment of the present invention.

FIG. 2: Shows a frontal elevation view of the current invention, adjustable crutch, constructed in accordance with the preferred embodiment of the present invention.

FIG. 3: Shows a side elevation view of the adjustable crutch. The side view shows a human holding the hand grip and being supported in standing position.

FIG. 4: Shows a roughly 45 Degree angled elevation side view of the adjustable crutch, used by a human in the seated position. The view shows a preferred embodiment of the invention and demonstrates the use of the crutch adjusted to be used to support a seated human.

FIG. 5: Shows a side cross section view of the cushion of the crutch.

FIG. 6: Shows a side cross section view of the rivets that will be used to secure the crutch's replaceable cover on the cushion.

FIG. 7: Shows a side view of the handgrip as it is connected to the crutch

FIG. 8: Shows a top view of the handgrip.

FIG. 9: Shows a top cross sectional view of the wrap around snap inlayed in the handgrip.

FIG. 10: Shows a top cross sectional view of the wrap around snap located in the conjunction of each two segment of the crutch shaft.

FIG. 11: Shows a side view of the elastic bottom part.

### DETAILED DESCRIPTION OF THE INVENTION

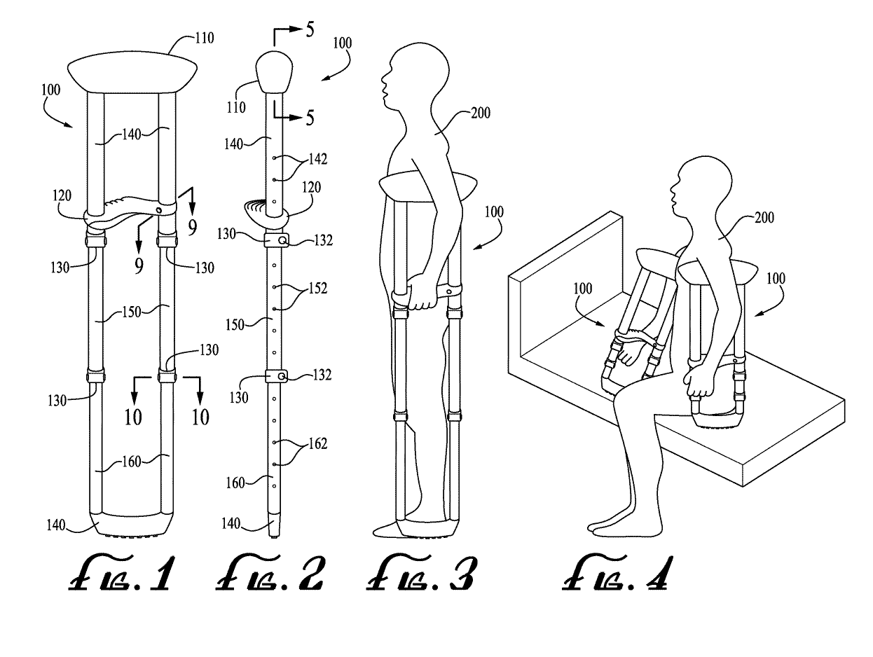

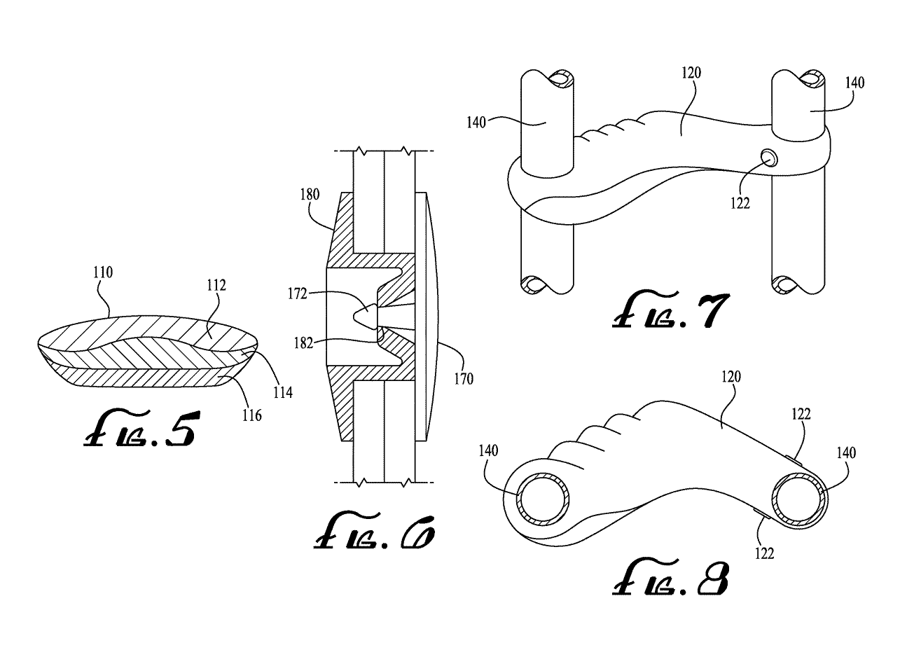

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the claims. The New Design for Crutches and Sitting Devices is an embodiment of a crutch comprising a pair of support shaft members. Each member is comprised of three shafts, 140,150 and 160. FIGS. 1 and 3, shows supporting member 140, the top member of the support shaft, while supporting members 150 and 160 also shown in FIGS. 1 and 2 are the middle and bottom members comprising the support staff. Each supporting element of the crutch, 140, 150, 160, is design to maintain the telescoping adjustable character and is of different internal and external diameters. Each support staff includes a plurality of adjustment holes shown in FIG. 2 as 142, 152 and 162. These adjustment holes receive the wrap around snap, FIGS. 9, and 10, which secures the members in place and prohibits for the members from sliding in a telescoping manner which facilitates the adjustability of the crutches. The supporting elements may be fabricated of metal such as steel aluminum, steel, or titanium or another appropriate material, and are formed in a generally hollow cylindrical shape.

The underarm support crutch cushion FIG. 5, and element 110 on FIG. 1, is located toward the proximal end of the support shaft member shown as 140, FIG. 1. and is comprised of Gel infused memory foam (open cell) cushion top layer of the underarm cushion to absorb jarring motions of ambulation, creating a more even and more comfortable ambulation.

Another embodiment of this invention is directed to a method of making a composite material of the underarm support crutch cushion, comprising: providing a layer of foam material.

The cushioning article or element as illustrated in FIGS. 1 and 5 may also comprises a barrier layer of thermoplastic polyurethane (TPU) as the middle layer of the cushion. In addition to the under arm support cushion, A trapezoidal shaped bottom element 140, FIG. 1 and shown in detail in FIG. 11 may be used at the distal end of support shaft element 160. The trapezoidal bottom is designed to assist in ambulating over uneven surfaces and to provide a cushioning effect. The trapezoidal shaped tip connected to both the front and rear end of the crutch provides appropriate friction between the crutch 100 and the walking environment. The trapezoidal curved shape of the base of the crutches provides a smoother, more even mode of ambulation, which is more natural and more comfortable for the user;

a. A walking aid support comprising a substantially trepazoidal bottom for engaging a walking ground; and

b. a pattern of “treads” or grooved patterns in the bottom of the trapezoidal base. The elastic base is made of a combination of softer (53 A Shore) and harder plastic (75 A Shore), which can provide a more solid grip on different surfaces, such as slippery ice, water, or uneven; and

c. The acute angle of the base is between about 0 degrees (at the midpoint of the base) and about 45 degrees (as it reaches each of the structural tubes).

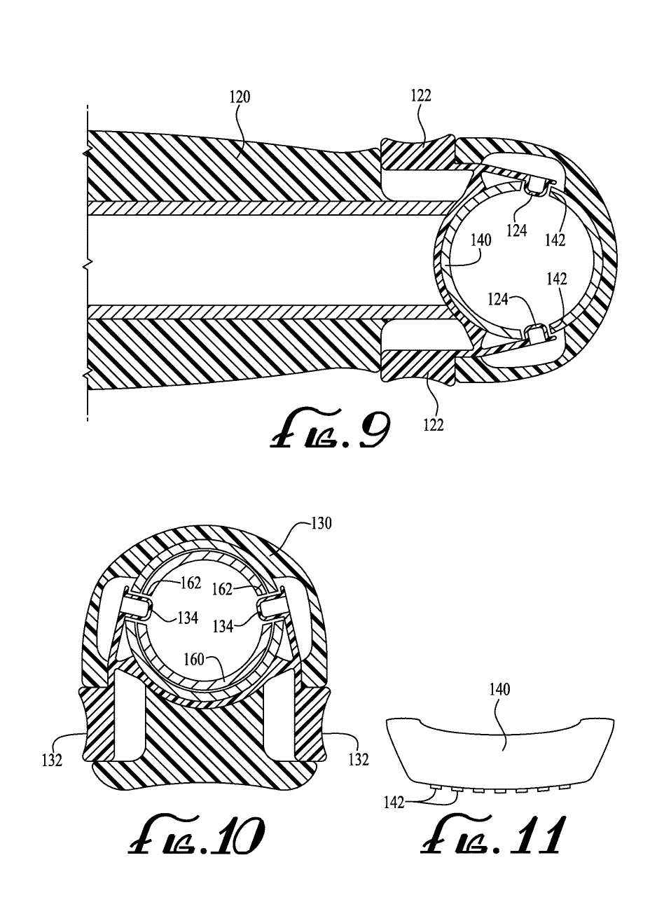

The hand grip 120 has the appropriate contours and ergonomic angulation to fit the palm and align the wrist. The hand grip 120 is shown in detail in FIGS. 7 and 8. FIGS. 8, shows that hand grip 120 has an angled offset from the rear from the range of 1.0″ to 3.0″. There is no offset distance from the forward tube and the design of the handgrip shows its triangular shape. The angle of the handgrip device FIG. 7 due to the difference between the back and front end vertical positioning is between 5 and 25 degrees down from rear to front.

The handgrip device, FIG. 8 is made or encased in a molded ergonomic grip shape for improved weight distribution.

a. The present crutch provides a hand grip that is comprised to two different plastics, one at 53 A and one at 75 A Shore; and

b. By mixing the pliability of the two different plastics, the grip has the ability to feel “dry” even when wet by perspiration or by weather; and

c. The grip of the crutch has grooves that are perpendicular to the lines of muscula tension, thus allowing for a steadier and stronger grip or grasp shown clearly in both FIGS. 7 and 8.

As indicated above, the crutch is adjustable and can be secured in various positions that ensure comfort and amelioration of injuries associated with normal use. Once adjusted to the appropriate height for the user, via telescoping effect of the 3 support members, 140, 150, 160, wrap around snap, 130, will be used to secure the support members in place. Alternative devices may be used as latching mechanisms instead of the illustrated wrap around snaps. For example, a single pin with a radial biased outward.

The present invention has for its primary object to provide a more comfortable and supportive mode of ambulation using an upgraded version of the traditional crutch, which can easily be converted into a sitting aid. When compared to current crutch designs, the present invention offers a number of improvements and I claim:

1. An adjustable crutch to aid mobility of a user in moving over various walking surfaces and support the user in the seated position. The adjustable crutch comprising: (a) two telescoping shaft elements each comprised of three tubes, an upper, middle and bottom tube, each of which is configured to slide in the adjacent lower tube to adjust the height of the crutch; (b) a hand grip element at the distal end of the upper tube. The hand grip is configured for the user to grasp to support the weight of the user; (c) a cushion configured to fit beneath an underarm of the person. The cushion being attached to proximate ends of the upper tubes; and (d) a crutch bottom or tip assembly configured to engage the walking surface when the person uses the crutches to move over the walking surface, the crutch bottom being attached to ends of the lower tubes.

2. The adjustable crutch of claim 1 wherein each of the pair of lower tubes is configured to slide inside one of the pair of middle tubes and the each pair of middle tubes is configured to slide inside one of the pair of top tubes, thus ensure adjustability of the height of the crutch via the telescoping characteristic of the tubes and ensures that the crutch can facilitate a height consistent with use of the crutch to support the user while seated.

3. The adjustable crutch of claim 1 wherein a more yieldable or pliable design of the armpit cushion, which will absorb shock incidence, creating a more comfortable and natural mode of ambulation; A more secure and stable support for the users' posture and torso which is attached directly to the tubular longitudinal structure, creating a more comfortable and less painful mode of ambulation or sitting position.

4. The adjustable crutch of claim 3 wherein the upper portion of the under-arm cushion FIG. 5, consists of a layer of gel-infused open cell memory foam material in direct contact with the cushion cover, extending from the upper surface of the cushion to the middle layer in which comprises of a soft and flexible plastic core piece, and the bottom layer ; the solid base in which supports the middle and top layer and is adjacent to the top end of the shafts.
The upper portion of the under-arm cushion is removable, so that users can clean or replace the “open cell ” unit, as it is vulnerable to under-arm perspiration and other forms of dirt; and the upper portion of the under-arm cushion can be removed and cleaned with common anti-bacterial soap/detergent and replaced on top of the middle portion; and the removable upper portion of the under-arm cushion is attached to the lower portion with embedded, protruding metal snaps; or rivets; and the removable upper portion of the under-arm cushion is also disposable, and new cushions can be ordered to replace these items should the user want to do so.

5. The adjustable crutch in claim 2 wherein a more secure and stable support for the user's posture which is attached directly to the tubular longitudinal structure, creating a more comfortable and less painful mode of ambulation or sitting. The support comprises a dual, parallel design of the supporting poles, providing more consistent and reliable ambulatory motion; a locking, wrap-around snap which includes pins that can be inserted into the openings is shown in FIGS. 9 and 10, and snap into place for the positioning of; the overall height of the crutch (for walking or as adjusted for sitting); and the length of distance from the under-arm cushion to the handgrip of the crutch; and the distance of the handgrip to the ground, which can be adjusted as a walking aid or as a sitting aid.

6. The adjustable crutch in claim 1 wherein the crutch has two support poles extending from the top of the crutch downward toward the ground comprising; a handgrip element handgrip device for an ambulation assistance; one handgrip element support pole attachment mechanism for each pole bridged by the handgrip element, wherein; the attachment mechanisms are user installable and removable, and provide a support for the handgrip element spaced outboard from the plane of the poles away from the body side of the crutch by an offset distance, there is no offset distance from the forward tube (thumb end) end of the handgrip while the offset distance from the rear tube, when installed on the crutch, a. The handgrip device of claim 3 wherein the offset distance from the rear tube is in the range of 1.0″ to 3.0″, or from 5 degrees to 25 degrees to maintain a stress-neutral position; and the vertical positioning of the forward end of the handgrip is lower to the ground from then the back end vertical positioning of the handgrip; and, the handgrip is curved outward relative to the plane of the support poles.

7. The adjustable crutch in claim 6 wherein the handgrip device offset distance from the rear tube is 1.00″ to 3.00″ inches, or from 5 to 25 degrees to maintain a stress-neutral position; the handgrip wherein the angle of the handgrip element due to the difference between the back and front end vertical positioning is between 5 and 25 degrees down from rear to front; the handgrip device is at least one made or encased in a molded ergonomic grip shape for improved weight distribution; the hand grip is comprised of two different plastics, one at 53 A and one at 75 A Shore which by mixing the pliability of the two different plastics, the grip has the ability to feel “dry” even when wet by perspiration or by weather; and the grip of the crutch has grooves that are perpendicular to the lines of muscular tension, thus allowing for a steadier and stronger grip or grasp.

8. The adjustable crutch of claim 1 wherein a trapezoidal or curved shape of the base of the crutches, to provide a smoother, more even mode of ambulation, which is more natural and more comfortable for the user; a pattern of “treads” or grooved patterns in the bottom of the trapezoidal or curved base, made of a combination of softer (53 A Shore) and harder plastic (75 A Shore), which can provide a more solid grip on different surfaces, such as slippery ice, water, or uneven surfaces; and the acute angle of the base is between about 0 degrees (at the midpoint of the base) and about 45 degrees (as it reaches each of the structural tubes);

9. The adjustable crutch of claim 2 wherein the crutch is designed and comprises a more secure, wrap-around locking snaps that allow adjustments from a walking crutch to an aid for sitting or getting out of a chair; crutch comprising a bottom portion, a top portion, a middle portion, and wherein wrap around snaps are used to secure the shaft element to one another and lock them in the height that they are adjusted to.
Wrap around snap comprise of two push buttons in which engage or disengage the pins which lock or unlock the telescoping shafts
